(19) United States
(12) Patent Application Publication
(10) Pub. No.: US 2010/0166951 A1
(43) Pub. Date: Jul. 1, 2010

(54) METHOD FOR MANUFACTURING WEAR LININGS FOR CASTING LADLES AND TUNDISHES

(75) Inventor: Slagnes Steinar, Aheim (NO)

Correspondence Address: CONNOLLY BOVE LODGE & HUTZ LLP, 1875 EYE STREET, N.W., SUITE 1100, WASHINGTON, DC, 20006, US

(73) Assignee: NORTH CAPE MINERALS AS, Aheim (NO)

(21) Appl. No.: 11/575,248

(22) PCT Filed: Sep. 2, 2005
(86) PCT No.: PCT/IB2005/003156

§ 371 Date: Nov. 12, 2008

(30) Foreign Application Priority Data
Sep. 14, 2004 (SE) 0402192-9

(51) Int. Cl. B22D 41/02; B05D 7/22

(52) U.S. Cl. 427/181

(57) ABSTRACT

The invention relates to a method of manufacturing of wear linings consisting of particulate refractory materials with a low thermal conductivity for casting ladles and tundishes for casting of metals. The so called water glass method is used for hardening the particulate material.

The present invention relates to a new method of producing refractory wear linings for casting ladles and casting boxes and to wear linings produced in accordance therewith. The invention also incorporates a number of different ways of utilizing the benefits offered by this new method of producing wear linings and various ways of further improving the characteristics thereof. What is meant by the technical term casting ladle will probably be quite clear, whilst by casting box we here mean the intermediate container which in continuous casting is used to distribute the melt to the actual continuous casting device.

As is evident from the designation wear lining, this part of the lining of the casting ladle or the casting box is by nature a consumable, and since it therefore needs to be replaced at regular intervals, the time it takes to replace the same and the work effort which has to be spent on this become financially critical factors.

The norm has previously been for this type of wear lining in casting ladles and casting boxes to have been constituted by refractory plates inserted on top of the more resistant lining thereof by means of bricklaying techniques, or alternatively by hardenable compounds of granular refractory material supplied by spraying, ramming or in some other way.

As the hardenable component and hence also as the binding agent in these spraying or ramming compounds, organic binding agents, such as phenol formaldehyde resins and carbamide formaldehyde resins, are nowadays generally used, but certain inorganic binding agents have also been used. Even though nothing so far, as far as we know, has been able to demonstrate that the most commonly found binding agent used for this purpose, the phenol resins, would be actually injurious to health, there are reports which indicate that they cause, inter alia, nausea amongst the engineers who have handled these products. Moreover, under prevailing environmental regulations, residual compounds containing phenol resin must not be readily deposited as refuse sand, but must be dumped with organic waste, e.g. household waste, which helps to break down residual phenols contained therein.

There is therefore already cause, on environmental grounds, to search for some new binding agent for the particulate refractory material which is currently used as the wear lining in casting ladles and casting boxes.

A number of different refractory materials with low thermal conductivity have previously been used to line casting ladles and casting boxes, both in the form of the abovementioned prefabricated blocks and in particulate form and, in the latter case, then as the principal component in the likewise above-mentioned hardenable compounds. The same particulate refractory compounds can be used as base components in the wear lining according to the present invention. Which refractory material in each individual case will be used in the wear lining according to the present invention is largely dependent on the type of molten metal which is to be used in the device which is lined therewith.

As examples of suitable refractory particulate materials of this type can be cited silicon dioxide, magnesite, aluminium oxide and aluminium silicates, such as chamotte, magnesium silicates, such as olivine, and carboniferous refractory materials such as crushed coke and blast furnace slag. Moreover, it is already previously known, in heat-resistant linings which are here at issue, to mix in small quantities of organic or inorganic fibre or sawdust, which are gasified when the end product, i.e. the lining, comes into contact with the melt and which thereupon forms pores which lower the thermal conductivity of the finished lining.

According to the present invention, it is now therefore proposed that, instead of the phenol resins which have hitherto most commonly been used, and any other hardenable components used for the same purpose, following the forming of the heat-resistant granular compound, this same shall be bound by reacting a mixture, already initially made therein, of a small quantity of water glass with supplied carbonic acid to form a siliceous gel, which rapidly binds the granular base material into a finished coating which acquires good natural rigidity, strength and binding against pre-existing more resistant lining. The invention means that both sodium water glass (sodium silicate) and potassium water glass (potassium silicate) can be used. In many cases, therefore, the general designation water glass will hereinafter be used. As a rule, a water glass admixture of somewhat over 4%, or perhaps, ideally, an admixture of 6-12% following the addition of carbonic acid, gives a sufficient quantity of siliceous gel to bind a particulate ground mass of the aforementioned kind.

The basic technique of binding granular refractory compounds by mixing in small quantities of sodium or potassium water glass, which, following forming of the compound, are reacted with carbonic acid, has previously been used within foundry practice in the production of primarily cores and moulds and in the lining of hot tops. The practice is described, for example, in Swedish patent application 4837 for 1956. As far as we know, the “carbonic acid method” which is described therein has hitherto never previously been proposed for the production of components as large as the wear linings on casting ladles and casting boxes, in which, moreover, the material solidified by the hardening of the carbonic acid is constantly placed in direct contact with a metal melt which, during at least parts of the contact period, will be moving and will therefore constitute an extremely wear-provoking medium.

It might seem obvious to transfer a known technique from hot tops to casting boxes and ladles, but the fact that this so far seems not previously to have been done, despite the “carbonic acid method” having been known within the foundry practice field since at least the 1950's, must be taken as an indication that this technological transfer has by no means been obvious to the person skilled in the art and working daily within the technical field in question.

The basic concept behind the invention is therefore to use the “water glass method” to produce wear linings for casting ladles and casting boxes, which thus intrinsically means that the wear lining of the casting ladle or the casting box is formed by a floatable compound of granular refractory material introduced between the more permanent lining thereof and a fixture lowered into the same, which compound has been fed at least 4% and preferably 6-12% sodium or potassium water glass and is likewise on the spot fed carbonic acid in a quantity which converts the water glass admixture into a sufficient quantity of siliceous gel to bind the particulate refractory material to a strongly cohesive body which entirely fills the space between the more permanent lining and the fixture, which latter can subsequently be removed. The carbonic acid supply can be realized, for example, through a system of ducts in the fixture.

As already stated, the “water glass method” has previously been used to produce moulds and heat-resistant linings of hot tops, i.e. products which are both smaller and exposed to less serious wear than the wear lining in casting ladles and casting boxes. In certain cases at least, there can therefore be a clear need to increase the strength of the wear lining produced according to the invention. According to a development of the invention, this is realized by an admixture of metal fibres, the mean fibre length of which exceeds by a comfortable margin the mean particle size of the particulate refractory material, but is not so long-fibred that it significantly impairs the floatability of the particulate base material containing the water glass. This means that the mean fibre length of the fibre material should not exceed 3-5 mm to any higher degree, whilst, at the same time, the mean fibre diameter of the fibres, for the same reasons, should not exceed 500 μm. Expediently, the metal fibre content will generally have to be tested for each individual field of application. Apart from the metal fibre admixtures which are now proposed with the present invention, those in part previously proposed fibre admixtures, such as organic fibres of the cellulose fibres and plastic fibres type and inorganic fibres of the glass fibres and ceramic fibres type, can also of course yield substantial advantages in this context.

As already stated, the concept of supplying fibre material to various refractory compounds which are used as the lining of metallurgical vessels is not new per se, but previously it has primarily involved the supply of organic fibre material, such as cellulose fibres, which were gasified when the lining came into contact with the molten metal and thereupon formed internal pores in the lining, which lowered its thermal conductivity. In Swedish patent application 76076819, which describes in great detail a continuous casting method in which the molten metal jet from the casting ladle is surrounded by a protective tube having a heat-resistant lining, it is mentioned that this lining, apart from the admixture of cellulose fibres, might also contain admixtures of asbestos fibres, aluminium silicate fibres and calcium silicate fibres. On the other hand, no direct information is given there about the function of these latter inorganic fibre types upon the finished lining material, which is otherwise said to contain an organic binding agent such as phenol formaldehyde or carbamide formaldehyde resin.

Since the basic principle for the present invention means that the desired wear lining on casting ladles and casting boxes is built up of a free-floating compound of particulate refractory material with low thermal conductivity containing a limited quantity of sodium or potassium water glass, which, before it is solidified through the supply of carbon dioxide, must fill the space between the more permanent lining of the casting ladle or the casting box and a matrix lowered into the respective object, it might be thought that it falls within the scope of the invention to produce suitable material for these matrices. With a development of the present invention, it is now proposed that these matrices are made of frigolite (polystyrene); an easy to handle, easily moulded and cheap material, which has the advantage, moreover, that matrices made thereof never need to be removed before the molten metal is supplied to the respective ladle or casting box. The frigolite has as a material, in fact, the, in this context, beneficial characteristic that at those temperatures which are prevalent in metal casting it is rapidly gasified and is combusted without producing any harmful quantities of residual products.

Since the frigolite is easy to mould, matrices of a desired shape can be easily produced. This means that the respective casting ladle or casting box can easily be given a new and fluidically substantially better shape than that which directly follows the outer metal shell of the respective object. The wear lining which according to the invention is built up of initially free-floating powdery material is not in fact dependent on being of wholly uniform thickness throughout, so that, if the shape of the matrix so allows, it can automatically be made to produce smooth corner transitions and other, for fluidic reasons, desired smooth transitions between the more right-angled parts of the casting ladle or the casting box.

Another advantage of using frigolite matrices which do not need to be removed prior to the supply of the molten metal is that they can be used to produce wear linings having an integrated, partially covering cover or roof. The only opening in the wear lining which would be needed is in principle precisely at the place where the molten metal is supplied.

Nor is there anything which directly states that a frigolite matrix must be made of compact frigolite. Since the material is easy to glue, subject to the right type of glue being used, then it is wholly conceivable to build hollow matrices whose outer shell produces a desired outer shape and whose inner shell only contains so much frigolite that the matrix has a satisfactory strength for the intended single usage.

The method of building up the wear lining which is here at issue, which method is characteristic of the invention, also means that it can be built up relatively simply into a number of layers, in which each layer consists of different types of heat-resistant material chosen from refractory particulate base materials previously enumerated, the material in the inner layer, in particular, being dependent on the metal melt which will be used. In the construction of such multilayered wear linings, the best method will probably be to work with a plurality of matrices with gradually increased volume, the space between the fixture with the greatest volume and the more permanent lining of the casting ladle or the casting box first being packed with particulate refractory material containing water glass, after which this particulate compound is fed carbon dioxide in sufficient quantity, the silicon dioxide gel which is hereupon precipitated causing the compound to solidify, after which the matrix which has so far been used is exchanged for one with a somewhat smaller volume and then new particulate water-glass-containing material is supplied to the space between the previously produced sub wearing layer and the smaller matrix, whereafter this material layer is solidified by a new admixture of carbonic acid, and so on. The number of sub wearing layers which are thereby constructed is in principle unlimited, but in most cases, in purely practical terms, consideration will probably only be given to fewer than five layers.

The multilayered methodology can also be used for the repair and strengthening of already used wearing layers. The method of building up a wear lining with the aid of a plurality of different successively increasingly small matrices also means that the different matrices do not necessarily need to be built up in the same way. One or more of these matrices might, for example, be constructed virtually like a balloon, i.e. inflatable, which would mean that, once the internal overpressure thereof has been eliminated, they could be removed through a quite limited opening in the finished layer of wearing compound.

The invention has been defined in detail in the appended patent claims and it will now be described only somewhat further in connection with the appended figures, whereof

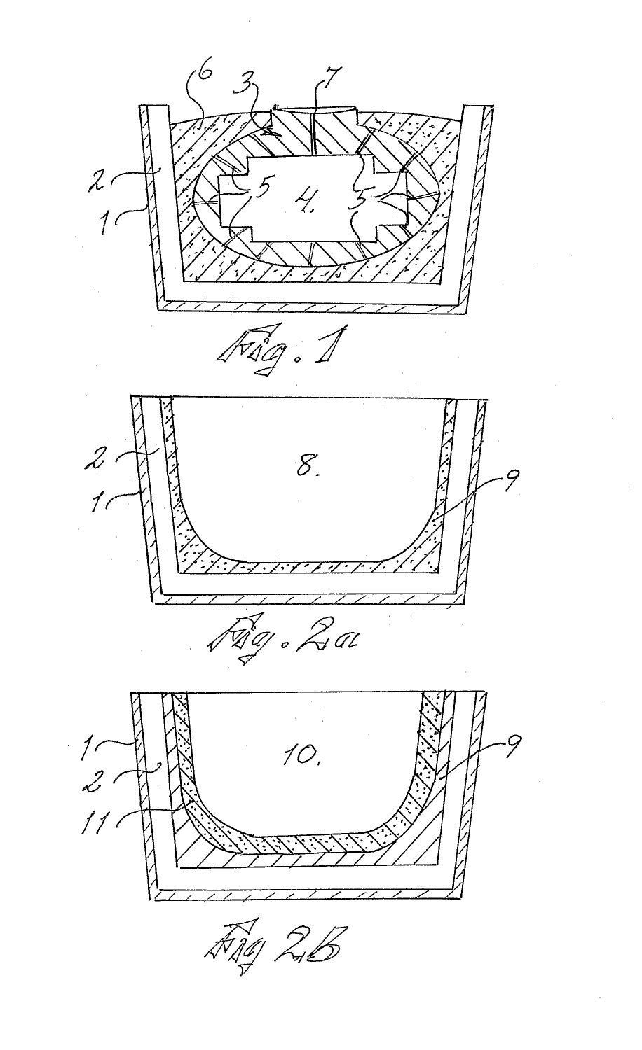

FIG. 1 shows a section through a casting box lined with the aid of a frigolite matrix, whilst FIGS. 2a and 2b illustrate the layered structure of a wear lining.

In all figures, 1 denotes the outer fixed wall of a casting box, whilst 2 likewise in all figures denotes the fixed brick-built protective lining of the same.

In FIG. 1, the reference 3 further denotes a preferably hollow matrix built up of frigolite parts (polystyrene parts), in which there are disposed feed orifices 5 for the supply of carbon dioxide from the hollow interior 4 of the matrix to the hardenable powder compound 6. The main intake for the supply of carbon dioxide to the interior 4 of the matrix 3 has been given the notation 7.

This latter is disposed in that part of the matrix 3 which, when the supply of a metal melt is initiated and the frigolite is eliminated, will form the inlet of the casting box. As is evident from the figures, the casting box will then, apart from the inlet, be covered by an integral lid. Since the outlet of the casting box is not affected by the invention, it is immaterial that this is situated beside the section shown in the figure.

The procedure according to the invention is briefly that the matrix 3 is fitted in the casting box in the desired position relative to the permanent lining 2, after which water-glass-containing powder material 6 according to the invention is supplied and possibly packed between the matrix 3 and the permanent lining 2, whereafter, once this has occurred, carbon dioxide is supplied to the inner cavity 4 of the matrix 3 and distributed to the powder material 6 via the feed orifices 5. Once the powder compound 6 has been solidified from siliceous gel which is thereupon formed, the device is ready for use.

In FIG. 2a, a first, larger matrix 8 is shown, which is equipped with carbon dioxide intakes (not illustrated in the drawing), and between this larger matrix and the permanent lining 2 there has been placed a first water-glass-containing powder layer 9, and as soon as this has been solidified through the supply of carbonic acid, the matrix 8 is removed and replaced by a somewhat smaller matrix 10, which, this too, has in-built carbon dioxide outlets, after which a new powder layer 11 is supplied between this smaller matrix and the previous powder layer 9 and then this second powder layer is solidified, whereafter the matrix can be removed and the casting box is ready for use.

1. Method of producing refractory wear linings (6, 9, 11) in casting ladles and casting boxes (1) intended for metal casting, the wear lining (6, 9, 11) being formed by a floatable compound, introduced between the more permanent lining (2) of the casting ladle or the casting box and a matrix (3, 8, 10) lowered into the same, of granular refractory material with low thermal conductivity containing at least 4% by weight and preferably 6-12% by weight of a sodium or potassium water glass, characterized in that the said compound is hardened in its entirety by means of siliceous gel precipitated from the water glass through the supply of carbon dioxide.

2. Method according to claim 1, characterized in that, as the granular refractory material, a number of different refractory materials are used, each containing a water glass admixture of the quantity specified in claim 1 and which are supplied successively in layers and which are hardened by the admixture of carbon dioxide and are given time to reach a satisfactory strength before the matrix (8-10) used in the formation thereof is replaced by a new one of smaller volume, and newly granular water-glass-containing compound of different basic composition is supplied for the formation of a next layer, which, in turn, is hardened by an admixture of carbon dioxide before a next layer is supplied and hardened.

3. Method according to claim 2, characterized in that, as the granular refractory materials, materials are used which have at least partially been based on olivine and so-called dead-burnt MgO (magnesium oxide).

4. Method according to claim 1 characterized in that into the compound of particulate material used to produce the wear lining there has been fed, apart from the water glass admixture, a fiber material in the form of metal fibers and/or organic fibers, such as cellulose fibers or plastic fibers, and/or inorganic fibers, such as glass fibers or ceramic fibers, the fiber material in question not being allowed to have a mean diameter significantly exceeding the mean particle diameter of the powder material.

5. Method according to claim 1, characterized in that, as the matrix for (3, 8, 10) for defining the interior space of the casting ladle or the casting box (1), which space is meant for the metal melt which is poured therein, a frigolite (polystyrene) matrix (3) is used which does not need to be removed before the melt is poured in, since this is destroyed by the heat of the melt.

6. Method according to claim 5, characterized in that the fact that the frigolite matrix (3), which melts away when the metal melt is supplied, does not need to be removed prior to the supply of the melt is used to give the casting ladle or the casting box an at least partially covering lid.

7. Method according to claim 5 characterized in that the frigolite matrix (3) is built up of a plurality of different parts around an empty core.

8. Method according to claim 5, characterized in that the empty interior (4) of the frigolite matrix, together with separate ducts (5) or other cavities in the frigolite, is used to supply carbon dioxide to the powder material (6, 9, 11) containing sodium or potassium water glass.

9. Method according to claim 1, characterized in that the wear lining is built up in a plurality of different layers (9, 11) between the more permanent lining (2) of the casting ladle or the casting box and a gradually retractable or shrinkable matrix (8, 10), each layer of refractory material having its specific composition but all of them containing an admixture of sodium or potassium water glass, which, prior to the supply of a next layer and through the supply of carbonic acid, is led to bind its specific layer internally and with adjacent layers by means of siliceous gel which is thereupon precipitated.

10. Method according to 2 characterized in that into the compound of particulate material used to produce the wear lining there has been fed, apart from the water glass admixture, a fiber material in the form of metal fibers and/or organic fibers, such as cellulose fibers or plastic fibers, and/or inorganic fibers, such as glass fibers or ceramic fibers, the fiber material in question not being allowed to have a mean diameter significantly exceeding the mean particle diameter of the powder material.

11. Method according to claim 3 characterized in that into the compound of particulate material used to produce the wear lining there has been fed, apart from the water glass admixture, a fiber material in the form of metal fibers and/or organic fibers, such as cellulose fibers or plastic fibers, and/or inorganic fibers, such as glass fibers or ceramic fibers, the fiber material in question not being allowed to have a mean diameter significantly exceeding the mean particle diameter of the powder material.

12. Method according to claim 2, characterized in that, as the matrix for (3, 8, 10) for defining the interior space of the casting ladle or the casting box (1), which space is meant for the metal melt which is poured therein, a frigolite (polystyrene) matrix (3) is used which does not need to be removed before the melt is poured in, since this is destroyed by the heat of the melt.

13. Method according to claim 3, characterized in that, as the matrix for (3, 8, 10) for defining the interior space of the casting ladle or the casting box (1), which space is meant for the metal melt which is poured therein, a frigolite (polystyrene) matrix (3) is used which does not need to be removed before the melt is poured in, since this is destroyed by the heat of the melt.

14. Method according to claim 4, characterized in that, as the matrix for (3, 8, 10) for defining the interior space of the casting ladle or the casting box (1), which space is meant for the metal melt which is poured therein, a frigolite (polystyrene) matrix (3) is used which does not need to be removed before the melt is poured in, since this is destroyed by the heat of the melt.

15. Method according to claim 6 characterized in that the frigolite matrix (3) is built up of a plurality of different parts around an empty core.

16. Method according to claim 6, characterized in that the empty interior (4) of the frigolite matrix, together with separate ducts (5) or other cavities in the frigolite, is used to supply carbon dioxide to the powder material (6, 9, 11) containing sodium or potassium water glass.

17. Method according to claim 7, characterized in that the empty interior (4) of the frigolite matrix, together with separate ducts (5) or other cavities in the frigolite, is used to supply carbon dioxide to the powder material (6, 9, 11) containing sodium or potassium water glass.

18. Method according to claim 2, characterized in that the wear lining is built up in a plurality of different layers (9, 11) between the more permanent lining (2) of the casting ladle or the casting box and a gradually retractable or shrinkable matrix (8, 10), each layer of refractory material having its specific composition but all of them containing an admixture of sodium or potassium water glass, which, prior to the supply of a next layer and through the supply of carbonic acid, is led to bind its specific layer internally and with adjacent layers by means of siliceous gel which is thereupon precipitated.

19. Method according to claim 3, characterized in that the wear lining is built up in a plurality of different layers (9, 11) between the more permanent lining (2) of the casting ladle or the casting box and a gradually retractable or shrinkable matrix (8, 10), each layer of refractory material having its specific composition but all of them containing an admixture of sodium or potassium water glass, which, prior to the supply of a next layer and through the supply of carbonic acid, is led to bind its specific layer internally and with adjacent layers by means of siliceous gel which is thereupon precipitated.
